(19) United States
(12) Patent Application Publication
(10) Pub. No.: US 2004/0188553 A1
(43) Pub. Date: Sep. 30, 2004

(54) Disc shredder

(76) Inventor: Hsien-Li Lo, Hsin Chuang City (TW)

Correspondence Address: BACON & THOMAS, PLLC, 625 SLATERS LANE, FOURTH FLOOR, ALEXANDRIA, VA, 22314

(21) Appl. No.: 10/397,208

(22) Filed: Mar. 27, 2003

(51) Int. Cl. B02C 18/16

(52) U.S. Cl. 241/36; 241/236

(57) ABSTRACT

The present invention provides a disc shredder, relating to a machine device disposed in a housing. A cover is assembled with the housing herein. The housing contains a motor, a fan, a reduction gear, a pair of cutter assemblies and a pair of tubes. The cover contains electrical components herein including a circuit board and a switch, and is connected to the motor by electrical cables. An inlet slot on the cover is for the insertion of floppy discs or CDs. When pressing the power switch, the fan and reduction gear are driven by the motor. The pair of cutter assemblies are then driven by the reduction gear and shred the disc. Splash plates on the sides of the inlet slot can prevent the risk of eye injury caused by flying debris.

### BACKGROUND OF THE INVENTION

1) Field of the Invention

The present invention relates to a disc shredder, more particularly a machine which shreds discs or CDs for the purpose of destroying classified data or recycling.

2) Description of the Prior Art

Most floppy discs and CDs are stored with computer programs or data. Since floppy discs and CDs are not as easily destroyed as paper, they mostly are arbitrarily discarded or recycled. Therefore, apart from not being environment friendly, the data saved in the discs is not secured since the discs are unable to be destroyed at one's convenience.

### SUMMARY OF THE INVENTION

The purpose of the present invention relates to a small shredder for the insertion of floppy discs or CDs which are shredded into tiny pieces and collected in a recycle bin. This not only destroys saved classified documents but also benefits recyclers.

### BRIEF DESCRIPTION OF THE DRAWINGS

FIG. 1 is a perspective drawing of the present invention.

FIG. 2 is a partial exploded drawing of the present invention.

FIG. 3 is a perspective structural drawing of the present invention.

FIG. 4 is a bottom sectional view of the machine device of the present invention.

FIG. 5 is a perspective drawing of the cover of the present invention.

FIG. 6 is a perspective drawing of a pair of cutter assemblies of the present invention.

### DETAILED DESCRIPTION OF THE PREFERRED EMBODIMENTS

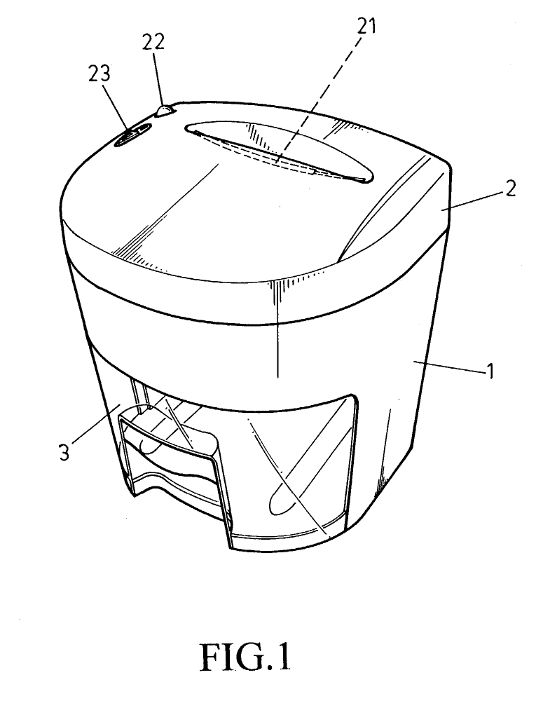

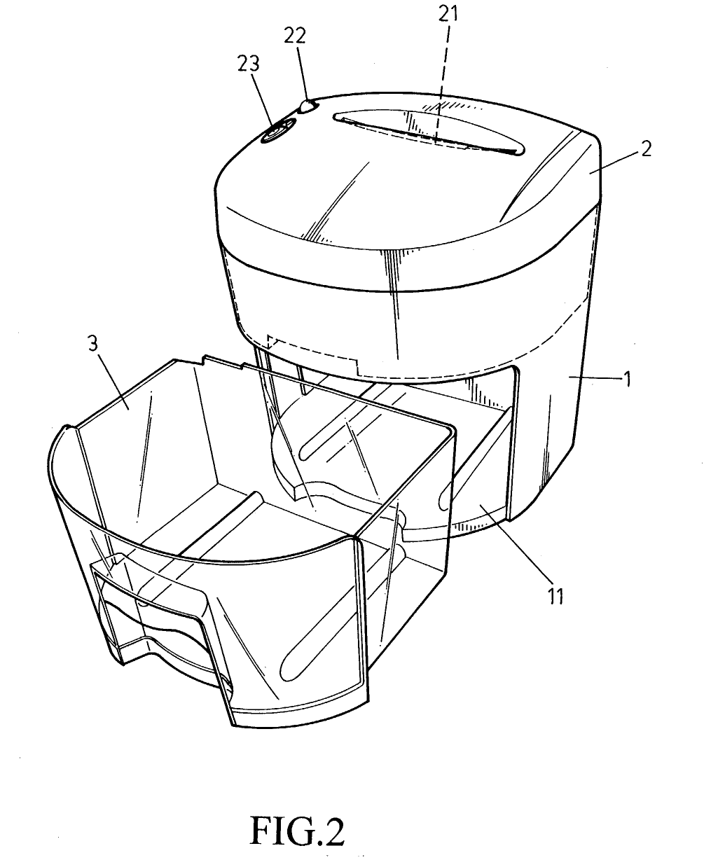

Referring to FIG. 1 and FIG. 2, the present invention relates to a housing appliance comprising a housing (1), a cover (2) and a recycle bin (3). A slot (11) at the lower part of the housing (1) provides a space for the recycle bin (3). The upper part of the housing (1) is the cover (2); an inlet slot (21) herein is for the insertion of floppy discs or CDs. A power switch (22) and a reverse switch (23) are also disposed on the cover (2).

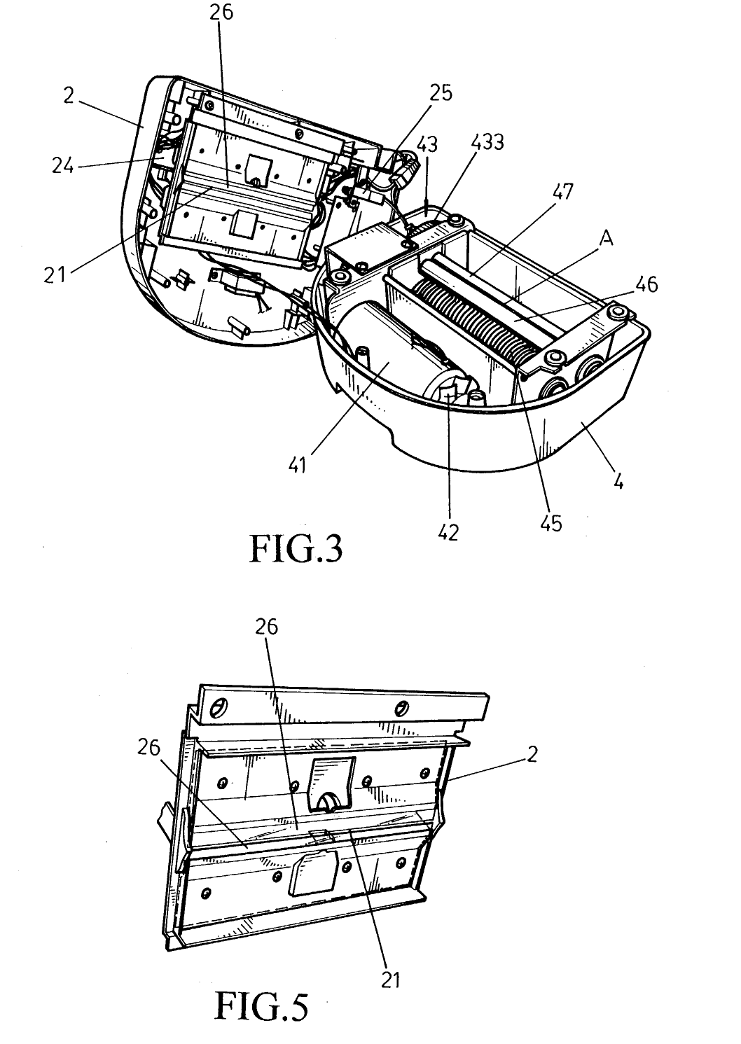

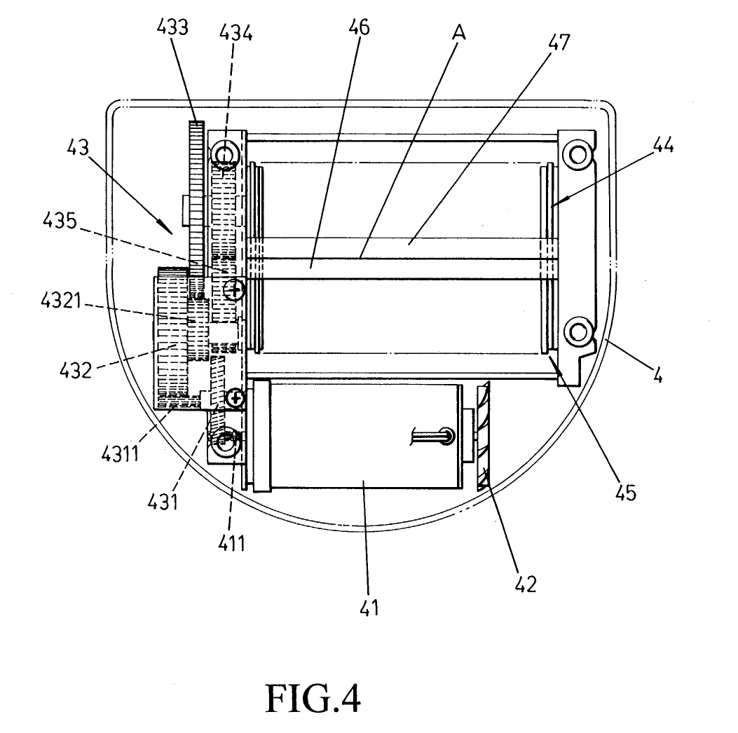

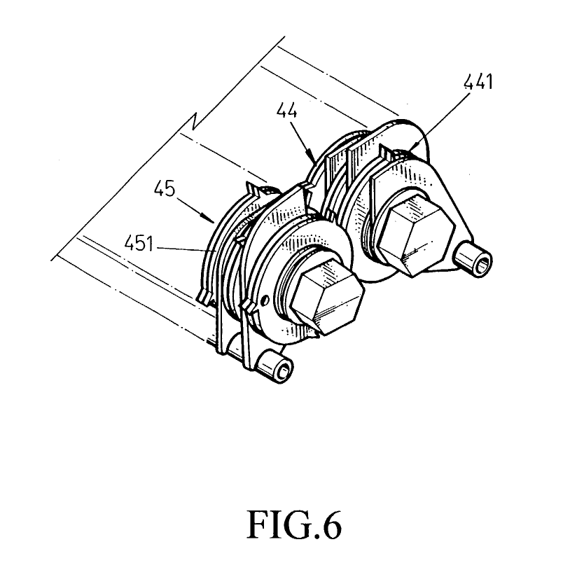

Referring to FIG. 3 and FIG. 4, a machine device (4) is disposed at the top of the housing (1) and assembled with the cover (2). The machine device (4) herein comprises a motor (41), a fan (42), a reduction gear (43), a pair of cutter assemblies (44, 45) and a pair of tubes (46, 47). The bottom of the machine device (4) opens to the recycle bin (3).

Said motor (41) drives the rotation of said fan (42) on one end and said reduction gear (43) on the other. As shown in FIG. 4, the reduction gear (43) is a reduction appliance composed of a plurality of gears. The axis (411) on the end of the motor (41) interlocks with a gear (431) of the reduction gear (43). The axis (4311) of the gear (431) interlocks with another gear (432); a small gear (4321) on the same axis as the gear (432) interlocks with a big gear (433) which shares axis with a small gear (434). Said small gear (434) also interlocks with an adjacent small gear (435). The axes of the two small gears (434, 435) interlock with said pair of cutter assemblies (44, 45) respectively. Therefore the reduction gear (43) is able to drive the rotation of the pair of cutter assemblies (44, 45).

A plurality of sawtoothed disc blades (441, 451) are disposed on the axes of the pair of cutter assemblies (44, 45). A pair of longitudinal tubes (46, 47) are disposed on the top of the pair of cutter assemblies (44, 45). Floppy discs or CDs can be inserted through the gap (A) between the tubes (46, 47) and then shredded by the pair of cutter assemblies (44, 45).

A circuit board (42) and a switch (25) are disposed inside the cover (2) and connected with the motor (41) by electric cables. A plastic splash plate (26) is disposed on each side of the inlet slot (21) located in the center of the cover, as shown in FIG. 5. The splash plates (26) can prevent the eye injury caused by the flying debris of the discs from the inlet slot (21) while shredding.

To sum up, the present invention shreds floppy discs and CDs. It not only can destroy classified documents, but also benefit recyclers.

1. A disc shredder provides a housing appliance comprising a housing, a cover, and a recycle bin; a slot under the housing provides a space for the recycle bin; the cover is located above the housing which contains an inlet slot for the insertion of floppy discs or CDs; a power switch and a reverse switch are disposed on the other end of the cover, which is characterized in that:
a machine device is disposed at the top of the housing, which is assembled with said cover; a motor, a fan, a reduction gear, a pair of cutter assemblies and a pair of tubes are installed herein; said motor drives the rotation of the fan and the reduction gear; said reduction gear drives the rotation of the cutter assemblies; the gap between the pair of tubes on the top of the cutter assemblies is for the insertion of discs, which then are shredded by said cutter assemblies; a circuit board and a switch are disposed inside of the cover and connected with the motor by electric cables; a splash plate is fixed on each side of the inlet slot in order to prevent eye injury caused by flying debris.

2. A disc shredder according to claim 1, wherein a reduction gear relates to a reduction appliance comprising a plurality of gears which are connected with the axis of the motor; the axis of the gears interlocks with another gear; a small gear sharing the same axis with the latter gear then interlocks with a big gear which shares the axis of another small gear; the latter small gear then interlocks with another adjacent small gear; this pair of small gears are connected with a pair of cutter assemblies respectively.

3. A disc shredder according to claim 1, wherein a plurality of sawtoothed blades are disposed respectively on the axes of the pair of cutter assemblies which work together in an indented way.
